(19) United States
(12) Patent Application Publication
(10) Pub. No.: US 2019/0274470 A1
(43) Pub. Date: Sep. 12, 2019

(54) COLD BREW COFFEE MAKING APPARATUS AND METHOD

(71) Applicant: WILBUR CURTIS CO., INC., Montebello, CA (US)

(72) Inventors: Brant David Curtis, Santa Clarita, CA (US); Patrick Michael Curtis, Rancho Santa Margarita, CA (US); Richard Henry Malone, III, Soquel, CA (US); Paul Gerald Foster, JR., Anaheim, CA (US); Harold Edward Reitberger, Westminster, CA (US); Winfred Ivan See, Diamond Bar, CA (US)

(21) Appl. No.: 16/213,976

(22) Filed: Dec. 7, 2018

Related U.S. Application Data
(60) Provisional application No. 62/639,666, filed on Mar. 7, 2018.

(51) Int. Cl. A47J 31/44; A47J 31/00; A47J 31/46; A23F 5/26; A47J 31/06

(52) U.S. Cl. CPC A47J 31/4403; A47J 31/002; A47J 31/06; A23F 5/26; A47J 31/46

(57) ABSTRACT

A coffee brewing apparatus and method that produces coffee using an agitation and cold brew operation. A high temperature strike stage with agitation is followed by a cold brew stage, with a vacuum configured to transfer the coffee oils and extracts, shortening the time necessary to achieve a brew cycle. The brewing cycle of the present invention preferably uses a six stage sequence that includes introduction of strike water, agitation, bloom, brew water introduction, vacuum transfer, and dilution. The various stages are performed using a brewing system that includes an agitation system, a vacuum system, and a filtering system used to extract the oils and extracts of the coffee for brewing.

### CROSS-REFERENCES TO RELATED APPLICATIONS

This application claims priority from U.S. Application No. 62/639,666, filed Mar. 7, 2018, the content of which is incorporated herein by reference in its entirety.

### BACKGROUND

Traditional coffee is brewed by grinding coffee beans into a granular size, or grounds, and then infusing the grounds with water at just below boiling to extract the essential oils and flavor-producing extracts of the beans. This extract is then mixed with water to produce the hot beverage. More recently, cold brew coffees have become popular. Cold brewing, also called cold water extraction or cold pressing, is the process of steeping coffee grounds in water at cool temperatures for an extended period. Coarse-ground beans are soaked in water for a prolonged period of time, usually 12 hours or more, typically in a refrigerated environment. The grounds are filtered out of the water after they have been steeped using a paper coffee filter, a fine metal sieve, a French press, or felt, in the case of the “Toddy” brewing system. The result is a coffee concentrate that is often diluted with water or milk, and can be served hot, over ice, or blended with ice and other ingredients such as chocolate or sugary syrups.

Because the ground coffee beans in cold-brewed coffee never come into contact with high temperature water, the process of leaching flavor from the beans produces a chemical profile different from that of conventional brewing methods. Coffee beans contain a number of constituent parts that are more soluble at higher temperatures, such as caffeine, oils and fatty acids. Compared to traditional brewing, low temperature brewing results in lower acidity and lower caffeine content when brewed in equal volume. In some cases, it is around 65 to 70 percent less acidic than hot drip coffee or espresso, and although less caffeine is extracted with the cold brew method, a higher coffee-to-water ratio is often used (e.g., 2-2.5). This reduction in water tends to compensate for the difference in solubility, resulting in a brew with equal, if not greater, caffeine to water ratio.

Although cold brewed coffee is growing in popularity, the method by which coffee is cold brewed can take eight to twelve hours or more. While this is acceptable for large scale sales, domestic and small commercial uses can find this inconvenient or impractical. Thus, it would be desirable to find a method and apparatus to accelerate the brewing process by which cold brewed coffee can be produced.

One example of an attempt to expedite the cold brew process can be found in WO 2016/164796 entitled “COLD BREW SYSTEM, METHOD, AND APPARATUS.” The '796 reference teaches the use of high pressure to extract the flavors of the coffee grounds in a reduced time. However, high pressure systems are not always suitable for domestic uses, and require specialized equipment to ensure safety and reliability. The present invention is a method and apparatus for achieving the cold brewing procedure without the use of high pressure.

### SUMMARY OF THE INVENTION

The present invention is a novel coffee brewing apparatus and method for producing coffee using a cold brew operation. In the present invention, a brief, high temperature brew stage is followed by a vacuum process to transfer the concentrated beverage to a keg or other vessel, shortening the time necessary to achieve a complete brew cycle. The vacuum process is far more effective than using gravity alone to transfer the concentrated beverage out of the brew chamber, and is better suited for home use and small commercial uses such as restaurants and the like.

The brewing cycle of the present invention preferably uses a six stage sequence that includes introduction of strike water, agitation, bloom, brew water introduction, vacuum transfer, and dilution. The various stages are performed using a brewing system that includes an agitation system, a vacuum system, and a filtering system used to extract the oils and extracts of the coffee or tea for brewing. A brew chamber is provided that may be open to the atmosphere, and preferably uses a metal or plastic screen to filter the extracts. A paper or metal filter is also used to remove finer particulate while allowing the oils and extracts to pass through. A controllable agitation system can be moderated to adjust the degree and duration of the agitation phase, where an agitation paddle is conveniently removable for cleaning. The vacuum system removes the concentrated beverage from the brew chamber to an intermediary container, such as a keg or sealed bag-in-box, prior to the dilution phase of the brew cycle.

These, and other features of the present invention, can best be understood with reference to the accompanying drawings in conjunction with the detailed description of the invention below.

### BRIEF DESCRIPTION OF THE DRAWINGS

FIG. 1 is a perspective view, partially in shadow, of a first embodiment of the present invention;

FIG. 2 is an enlarged, perspective view of a brew chamber and clamping mechanism of FIG. 1;

FIG. 3 is an exploded view of the brew compartment of the embodiment of FIG. 1;

FIG. 4 is an exploded view of an alternate brew compartment;

FIG. 5 is an elevated, perspective view of an agitation paddle of the embodiment of FIG. 1;

FIG. 6 is an elevated, perspective view partially in shadow of a second embodiment of the present invention;

FIG. 7 is an exploded view of a brew chamber and vacuum coupling;

FIG. 8A is an exploded side view, partially in shadow, of the vacuum coupling;

FIG. 8B is a side view, partially in shadow, of the vacuum coupling of FIG. 7;

FIG. 9A is a graph showing a brewing sequence for the present invention;

FIG. 9B is a graph showing a second brewing sequence for the present invention;

FIG. 10 is an elevated, perspective view, partially in shadow, of the agitation system of the present invention;

FIG. 11 is an elevated, perspective view of the agitation system;

FIG. 12 is an exploded view of the agitation system; and

FIG. 13 is a schematic view of the beverage reservoir and pump/brew chamber arrangement.

### DETAILED DESCRIPTION OF THE PREFERRED EMBODIMENTS

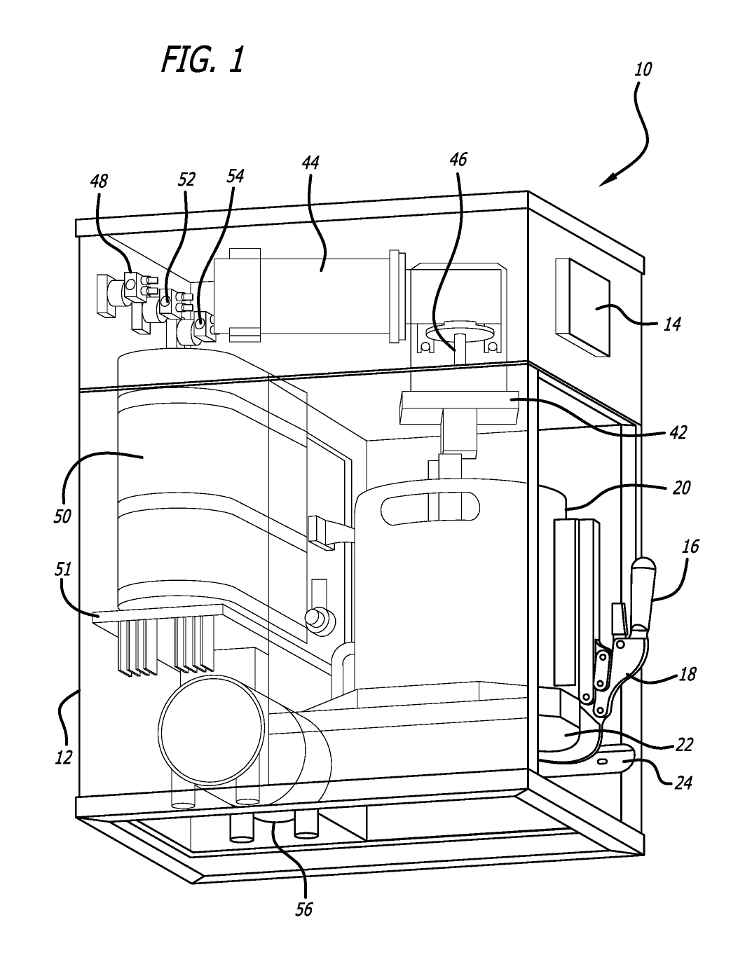

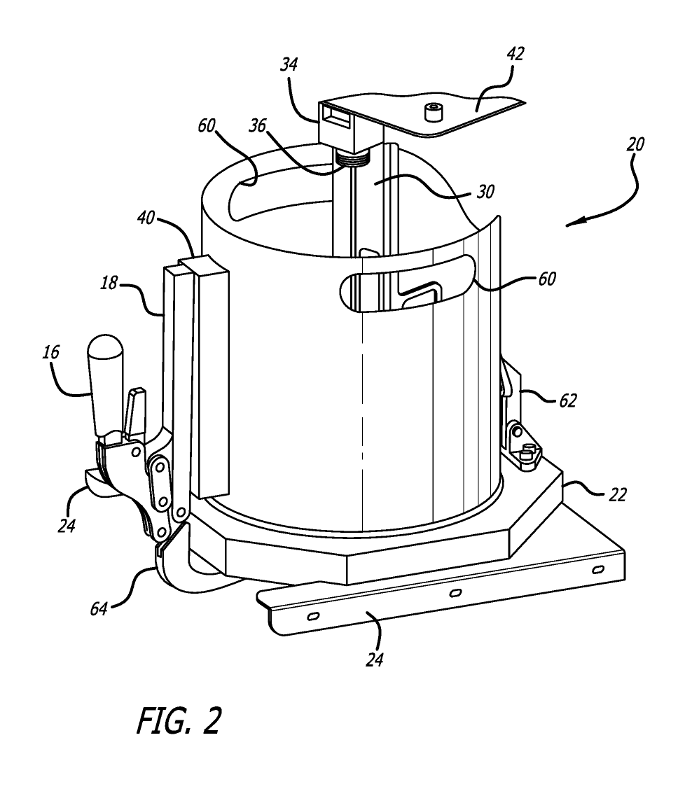

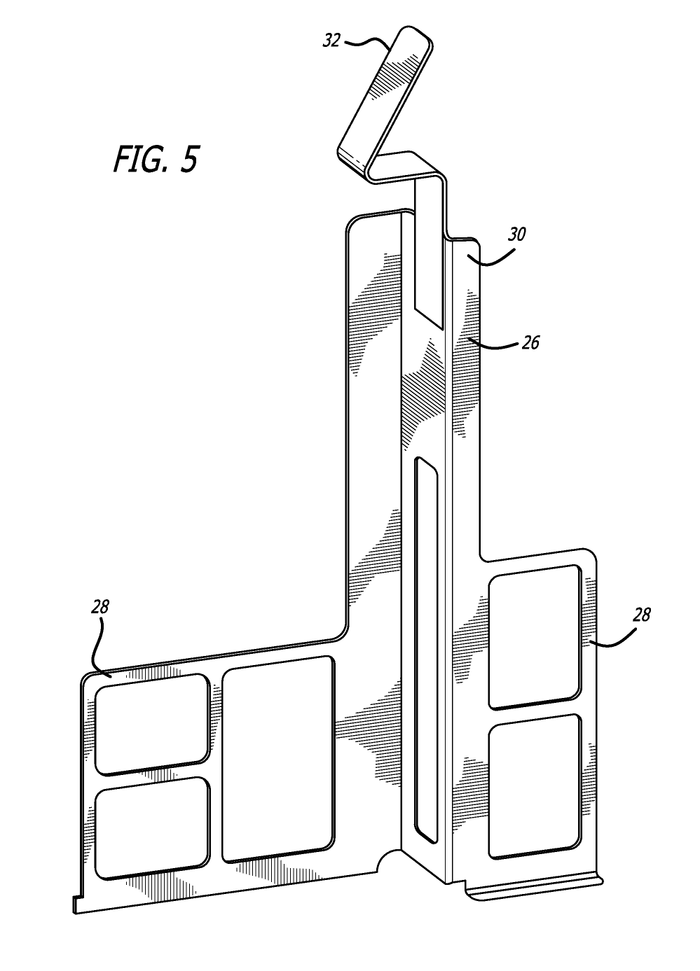

FIG. 1 illustrates the components of a cold brew coffee brewing apparatus 10 embodying the features of the present invention. The apparatus 10 includes a sturdy housing 12 that holds and encloses the components of the brewing apparatus. A control pad 14, which may be a touch screen or other key pad device, allows a user to enter information to be used in a brewing operation, such as brew volume quantity, brew time, agitation time, vacuum time, preferences (strong, weak, etc.), as well as provide information such as a timer from indicating completion of the brewing operation. On the front of the housing 12 is a lever 16 that is connected to a linkage 18 that clamps a brew chamber 20 to a chamber base 22. The brew chamber 20 is cylindrical and has a mounting block 40 on an exterior surface that engages with the linkage 18 to clamp the brew chamber 20 in place (see FIG. 2). A base 22 is mounted to first and second rails 24 so as to position the brew chamber 20 in proximity with an agitation paddle 26 (see FIG. 5). The agitation paddle 26 is seated within the brew chamber 20 and comprises first and second panels 28 that help stir the grounds for better wetting and extraction. The agitation paddle 26 includes a neck 30 having an upwardly projecting tab 32 that is received by a coupling 34 using a locking nut 36. The coupling 34 depends from a faceplate 42 which is part of the agitation motor assembly 44, which includes a motor 46 to turn the agitation paddle 26. The agitation motor assembly 44 is controlled by a processor (not shown) that may be part of the control pad 14 and sends signals to the motor assembly 44 to initiate, control, and terminate an agitation step.

FIG. 1 also illustrates a water delivery system that includes a valve 48 for filling the hot water tank 50 mounted on a shelf 51, a valve 52 that introduces ambient water to mix with the hot water, and a valve 54 used to dilute the concentrated coffee after ground extraction. Connections between the hot water tank 50 and the brew chamber 20 are omitted for clarity.

The apparatus is also equipped with a vacuum pump 56 for generating a negative pressure in the conduit that is connected to the bottom of the brew chamber 20. The vacuum pump 56 is controlled by the processor in the control pad 14, which activates and deactivates the pump 56 as part of the vacuum transfer process.

FIG. 2 is an enlarged view of the brew chamber 20. The brew chamber 20 has two elongate slots 60 that can be used to grip the brew chamber 20, and a support bracket 62 that positions the brew chamber 20 on the chamber base 22. A clamp 64 secures the brew chamber 20 to the chamber base 22 as the lever 16 is pivoted, and releases the brew chamber 20 from the chamber base 22 when the lever 16 is pivoted in the opposite direction.

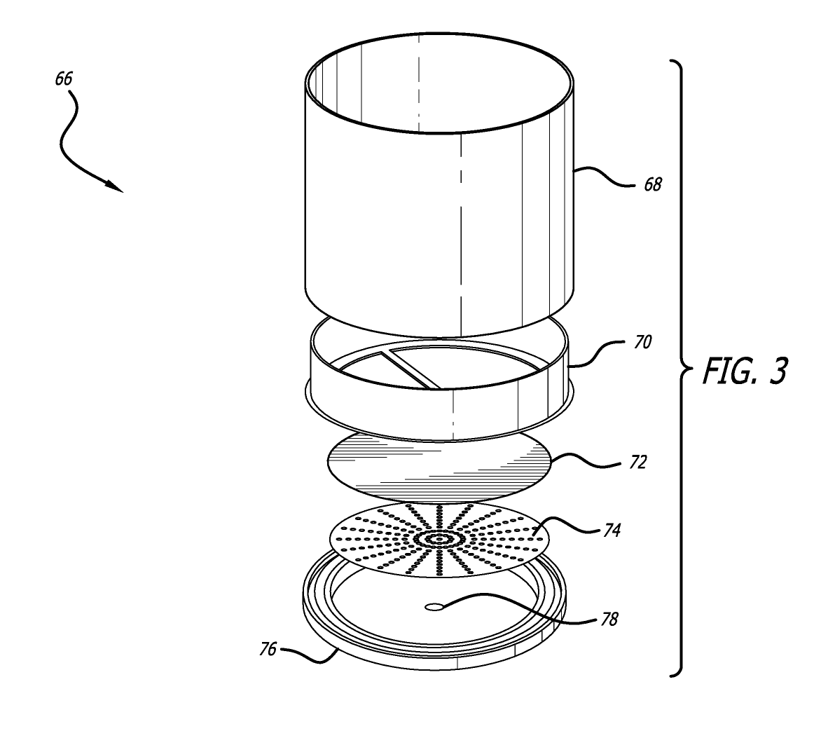

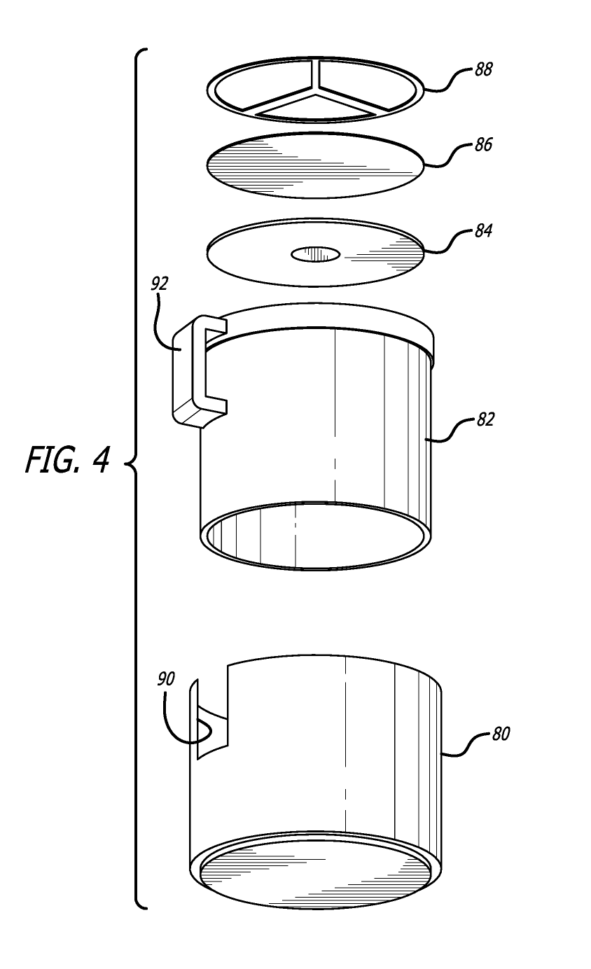

FIG. 3 illustrates an exploded view of the components of the assembly 66 that fits inside the brew chamber 20. The brew assembly 66 comprises a cylindrical brew sleeve 68, a silicon or plastic base 70, a paper filter 72, a perforated metal or plastic filter 74, and a locking cap 76 having a central aperture 78. The assembly fits into the brew chamber 20 and seals the chamber to form an air tight compartment. FIG. 4 illustrates an alternative assembly comprising a brew chamber 80, a brew basket 82, a perforated plate 84, a filter 86, and cross plate 88. It can be seen that the brew chamber 80 includes a slot 90 that receives a lug 92 on the brew basket 82 to capture the basket in the chamber.

The control pad 14 may include electronics that allow the processor to be accessed by a phone or tablet in order to control the apparatus, using either a Bluetooth connection or some other wireless connection. This can be accomplished through an application downloaded onto the phone or tablet, or other graphic interface on the phone. The phone, or the device itself, can access a remote server to recall recipes, software updates, tips, and other user information.

A preferred brew sequence is now be described in detail. The first stage is a strike phase, where the brew cycle begins with the introduction of water via valve 48. The water wets the grounds in the brew chamber, initiating the extraction of the oils and extracts of the ground coffee beans. During the strike step of the brew cycle, a target strike water temperature is 201° F.+/−4 degrees, as this temperature has been found to effectively target soluble acid and sugar in coffee grinds while avoiding adversely scalding of grinds. The target quantity of water is 96 ounces to 112 ounces, depending on coffee amount driven by recipe.

A few seconds after the strike water is introduced, the agitation motor is activated to initiate the agitation phase of the process. During the agitation phase, strike (hot) water is continually added from the hot water tank 50 to the brew chamber 20. During the agitation phase, the agitation paddle 26 stirs the coffee/water slurry for one to two minutes. The motor assembly 44 rotates the paddle 26, for example, at about 140 to 170 revolutions per minute, thereby fully wetting the grounds and preparing the grounds for extraction.

After the agitation phase, a thirty (30) second delay is initiated where the grounds settle and the strike water permeates the grounds. After the pause, the beginning of brew cycle phase is initiated by the introduction of ambient temperature brew water into the mixture. An exemplary target temperature is 50-80 degrees F., and coffee extraction efficiency is mostly unaffected within this ambient temperature range. An optional hot brew water phase can be used in place of the ambient brew water phase. The ambient water valve 52 remains open for one to two minutes to fill the brew chamber 20, where a typical target brew water volume is two gallons. The controller begins and ends all of the operations, and the timing can be adjusted to the tastes of the user. The introduction of the ambient water in the brew cycle phase results in a short bloom phase wherein the coffee bed settles and levels in preparation for vacuum transfer.

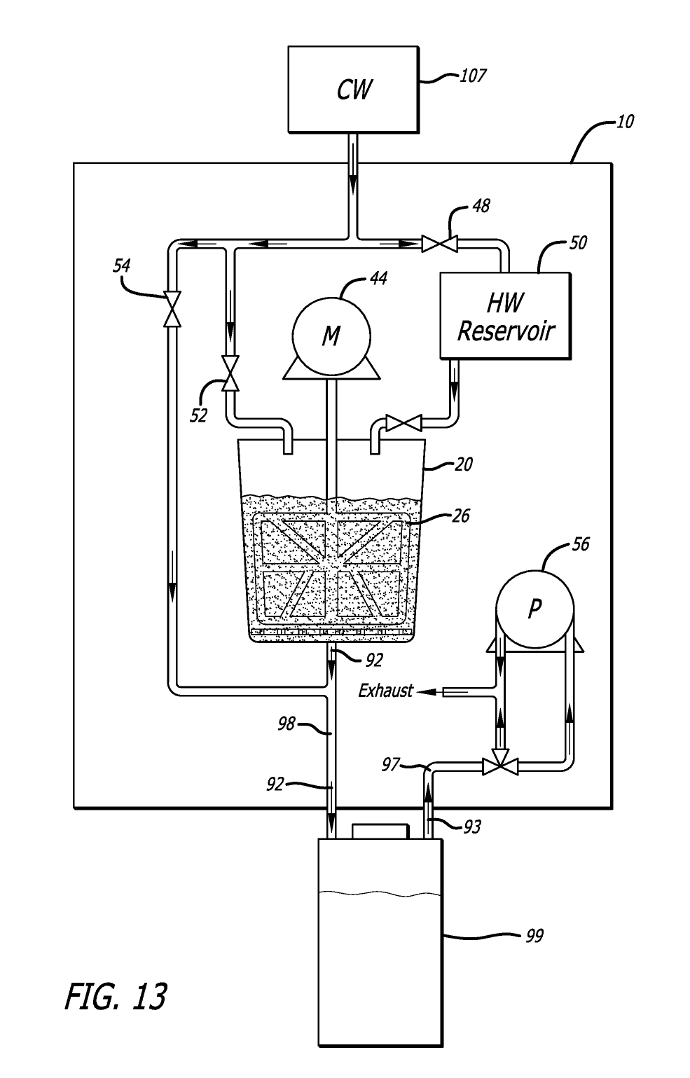

Concurrently, at the initiation of the bloom phase the vacuum pump 56 (FIG. 13) that is attached to a five gallon keg 99 or a bag-in-box by a conduit 97. Cold or ambient water is delivered to the apparatus 10 by cold water supply 107, which is routed into either the hot water heater 50, the brew chamber 20, or the keg 99 as needed. The opposite end of the keg 99 or bag-in-box is then connected to the brew chamber 20 by conduit 98. The vacuum pump 56 creates a negative pressure that is communicated to the keg 99 as air flows in the direction of the arrow 93, which in turn helps draw the beverage from the brew chamber 20 to the keg 99 or bag-in-box as a gravity assist mechanism in the direction of arrow 92. This transfer phase may take between 8 minutes to 15 minutes, depending on recipe. The range in time is driven by grind size, strike volume, and brew water volume as dictated by programmed recipe or user customized recipe.

Once the transfer process is completed, the keg 99 is depressurized by the control pad 14, and bypass water from valve 54 is introduced directly to the keg to dilute the concentrated beverage. The period of bypass water introduction is dependent on bypass water flow rate through the valve 54, where a typical volume would be on the order of two to two and one half gallons. This allows the concentrated coffee from the vacuum transfer process to be diluted to yield the proper ratio of concentrate to bypass coffee.

Parameters that are controllable using the apparatus of the present invention includes coffee amount (approximately 3.0 pounds to 4.0 pounds driven by recipe), flavor profiles adjusted by manipulating the extraction rates of targeted acid, sugar, and dry distillation flavors inherent in coffee grinds, and grind size (fine to medium fine, for example).

In some embodiments, a two phase brew water cycle can be employed for better mixing and cooling of the beverage and reduced condensation in the keg and vacuum.

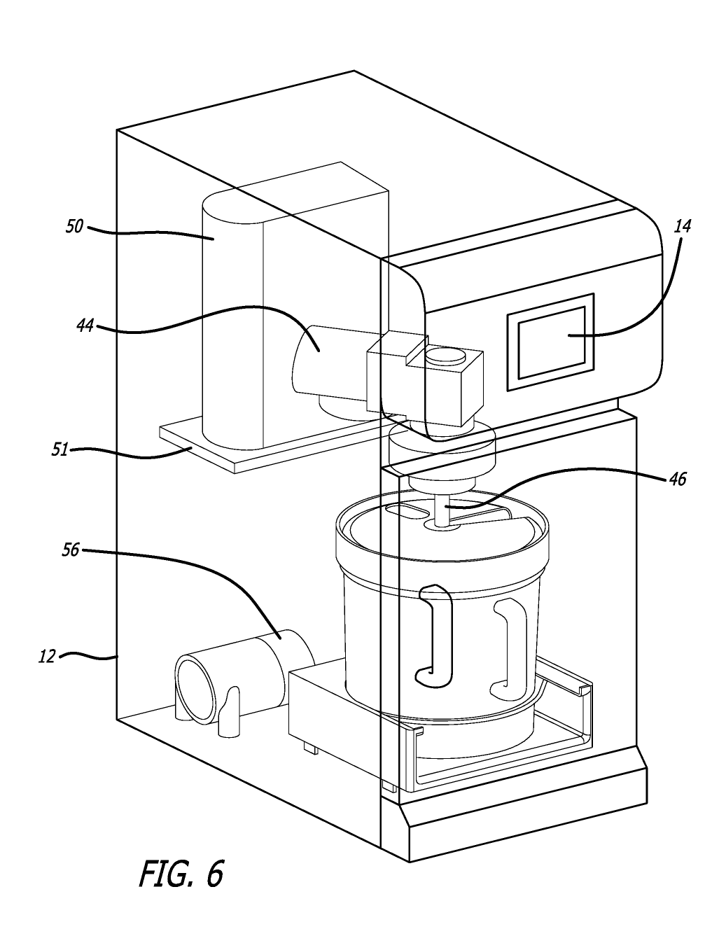

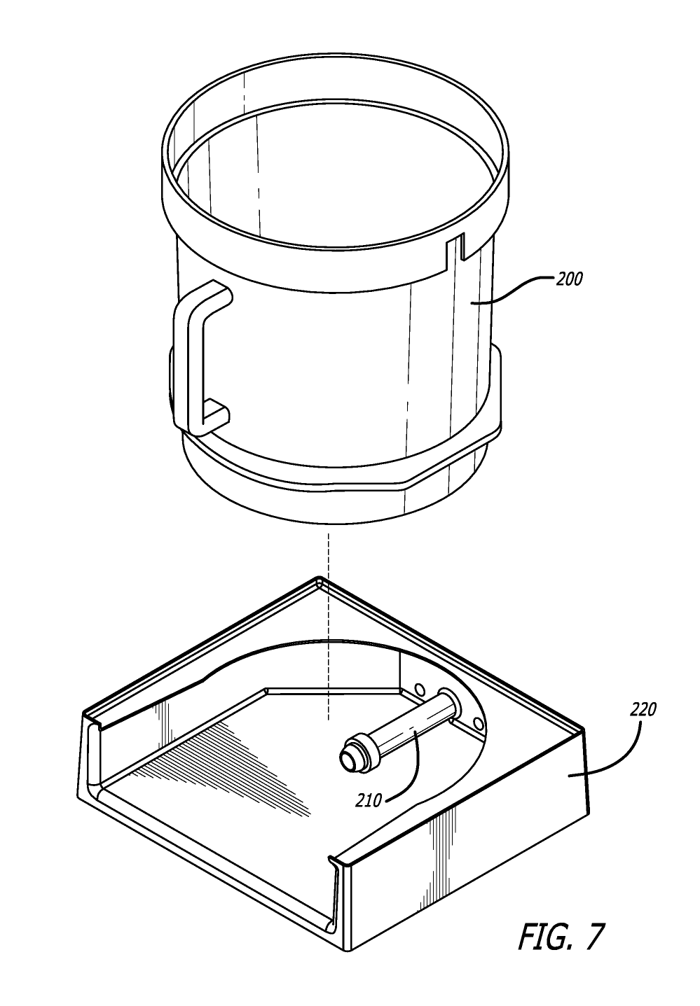

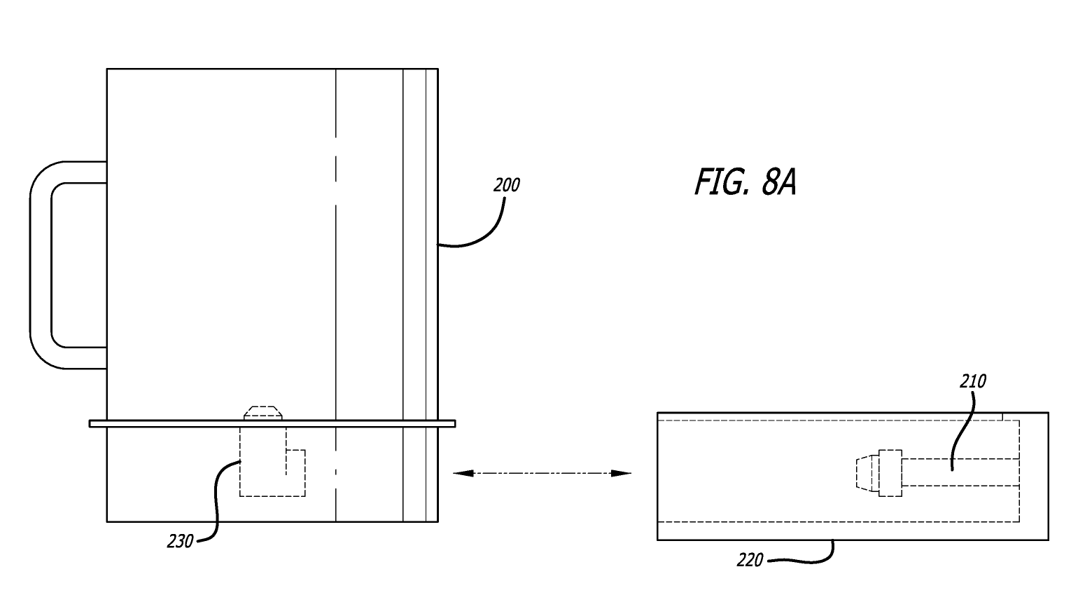

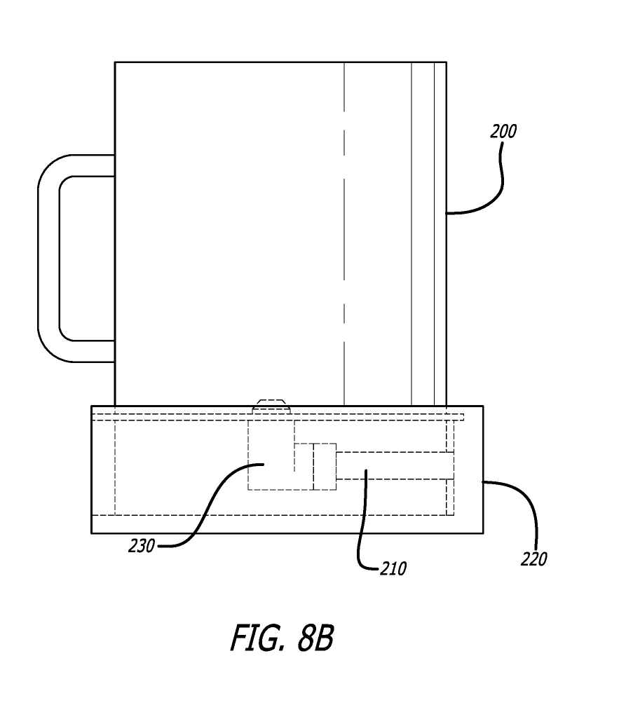

FIG. 6 illustrates a second embodiment of the present invention, where like elements repeat like reference numbers. Housing 12 encloses a brew chamber 200, vacuum pump 56, base 22, and agitation assembly. As seen in FIG. 7, the brew chamber 200 couples to its base 220 and a stem 210 in the base 220 locks into a vacuum port fitting 230 (FIG. 8A,B) to communicate the negative pressure to the brew chamber. The brew chamber receives the stem like a socket and provides a fluid path from the vacuum pump to an external key or bag-in-box, and then to the brew chamber through the base 220. In a preferred embodiment, the brew chamber 200 is slid horizontally into the base 220, causing the stem 210 to engage the fitting 230 and opening the vacuum path through the stem (connected to the vacuum 56 in series with a keg or bag-in-box via hose) to inside the brew chamber 200. This allows the brewed beverage to be drawn from the brew chamber through the filters and interceding elements into the keg or bag-in-box to significantly reduce the overall brew time.

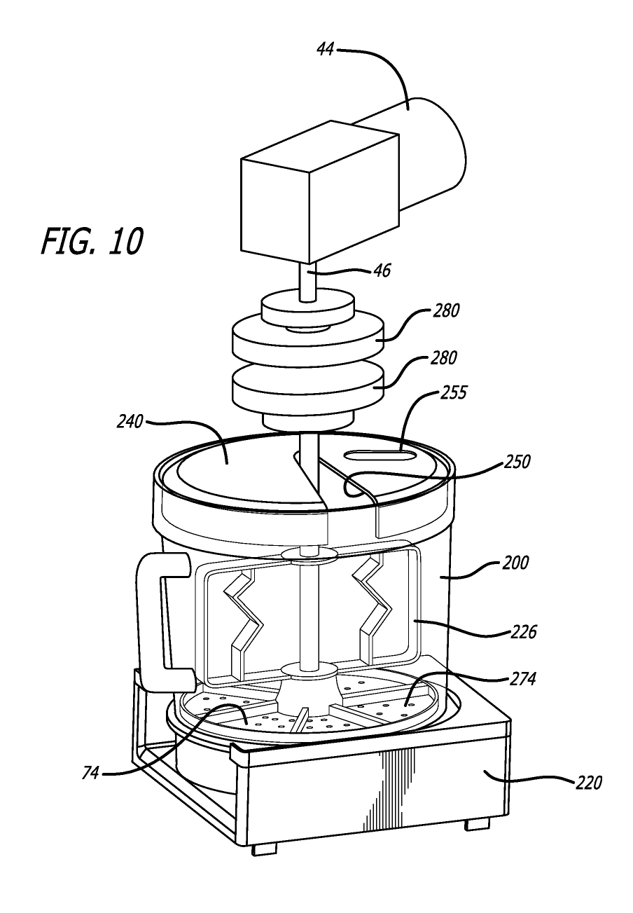

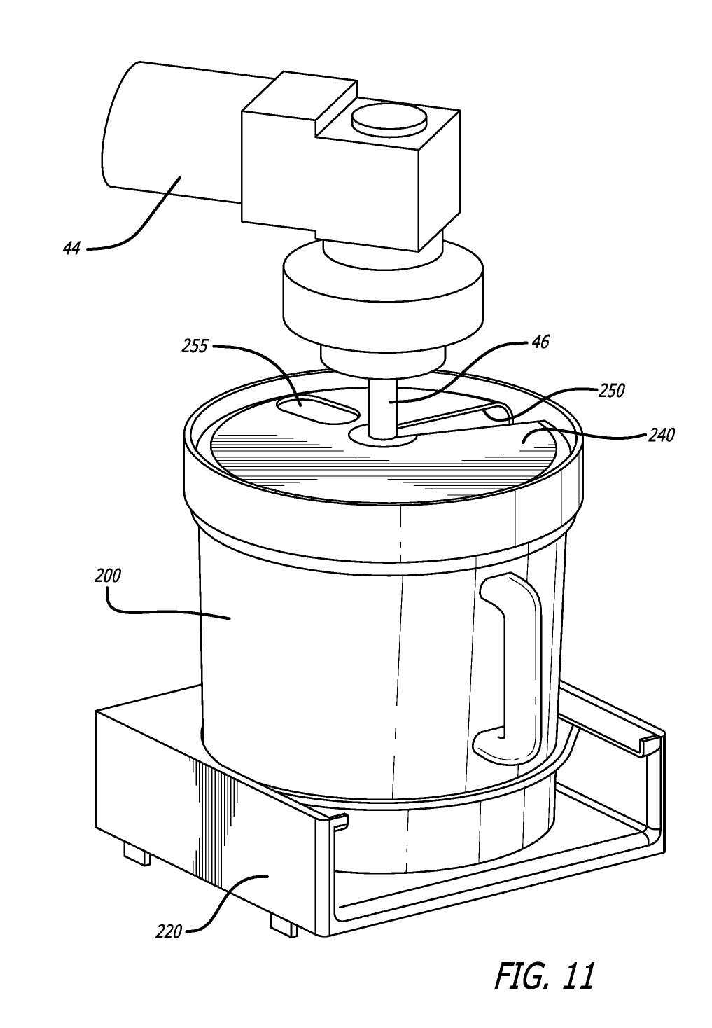

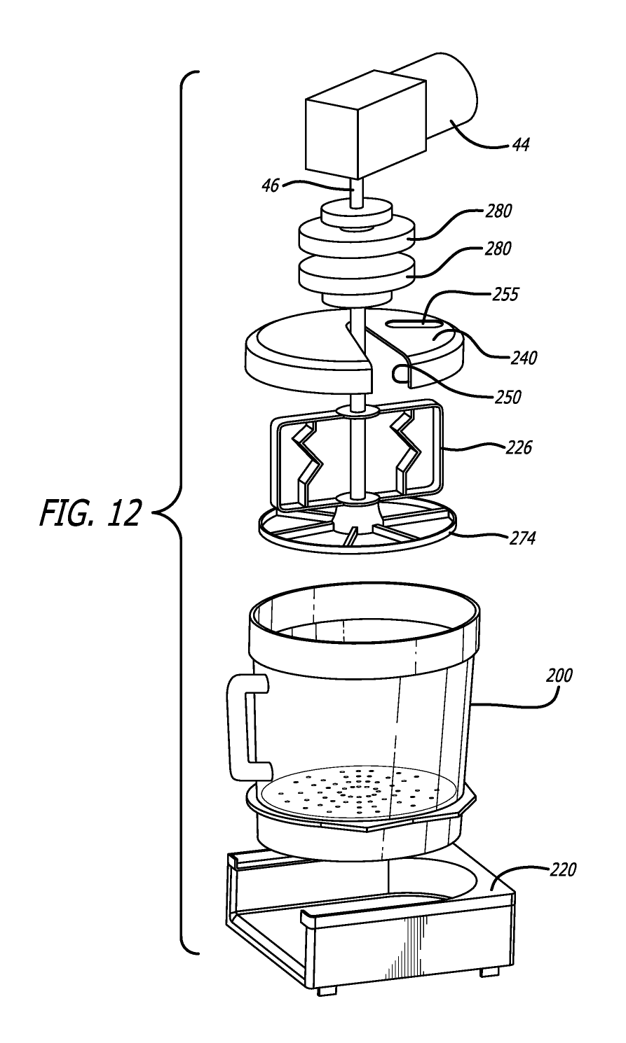

FIGS. 10 and 11 show the agitation system, where motor 44 turns axel 46 that rotates paddle 226. This paddle stirs the grounds and ensures adequate wetting during the various phases of the brew cycles. In a preferred embodiment, the paddle 226 is connected to the axel by a magnetic coupling 280 for easy removal and cleaning. The base 274 of the brew chamber 200 includes apertures that allow the negative pressure from the stem 210 to reach the brew area where the grounds are stirred. A cover plate 240 can be rotated using a finger slot 255 so that the wedge shaped opening 250 is closed during the agitation phase to prevent splashing, and then rotated back so that the brew chamber 200 can be easily removed from the base 220. FIG. 12 shows an exploded view of the agitation system, with motor shaft 46 connected to the paddle 226 via magnetic coupling of the paddle 281, and the cover 240 enclosing the brew chamber 200 that is seated in the base 220.

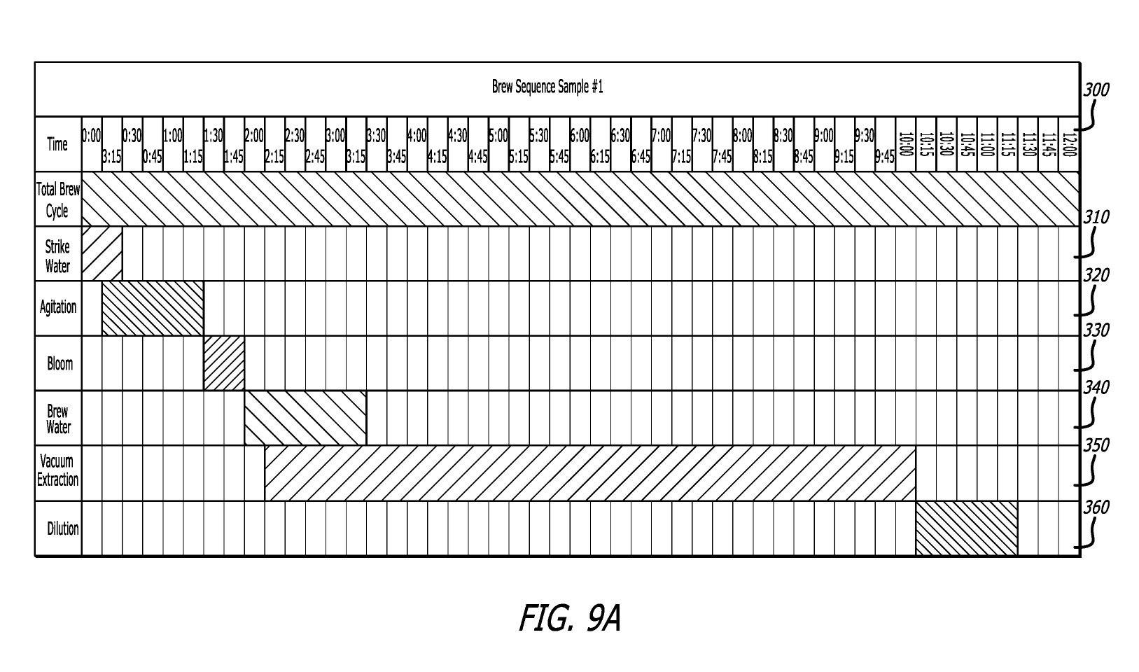

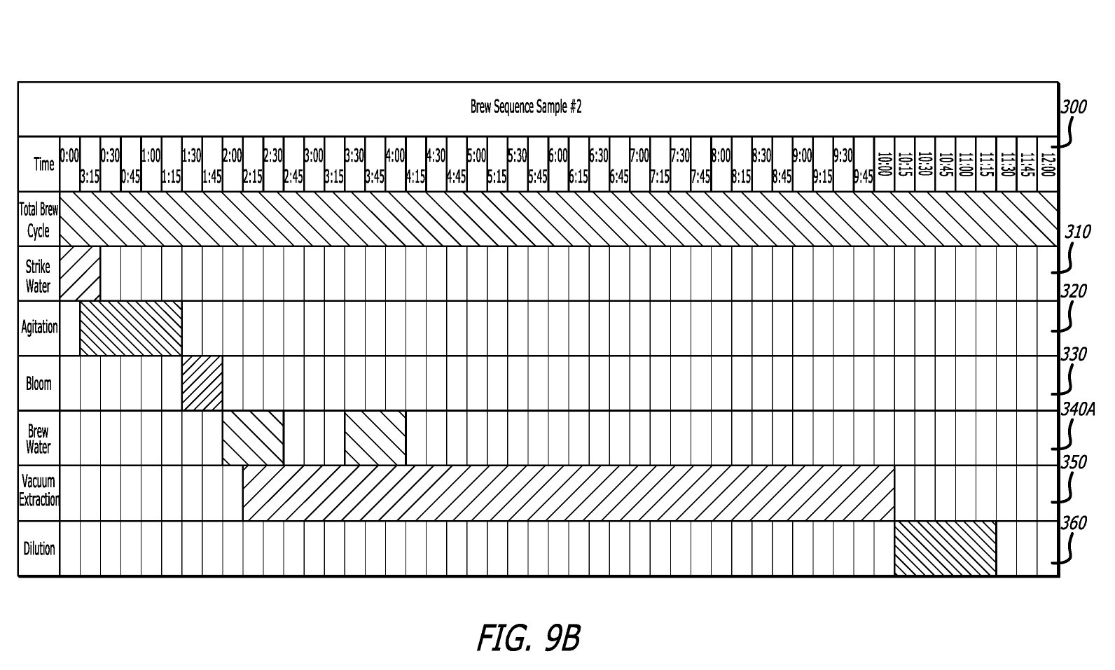

FIGS. 9A and 9B illustrate two brew operations that can be conducted with the present invention. Using the timeline on the upper bar, a twelve minute process is depicted in FIG. 9A. The strike water phase 310 occurs in two periods from zero to thirty seconds. The agitation phase 320 begins shortly after the first strike water phase is initiated and lasts for just over a minute. The agitation phase 320 is followed by a brief thirty second bloom phase 330, followed by a one to two minute brewing phase 340. The brewing phase is shortly after the brew phase 340 begins, vacuum transfer 350 begins and lasts for approximately eight minutes. Finally, after vacuum transfer 350 the dilution phase 360 begins where water is added to the concentrate to make the drinkable beverage. In FIG. 9B, the brewing phase 340A has a secondary brew water phase after a delay.

While several embodiments have been disclosed in the foregoing description and in the drawings, the invention is not limited to any described or depicted embodiment. A person of ordinary skill in the art would readily recognize and appreciate many modifications and substitutions to the embodiments described, and the present invention is intended to include all such modifications and substitutions.

1. A beverage brewing system comprising:
a non-pressurized, removable brew chamber;
an agitation motor;
a removable agitation paddle rotated by the agitation motor and disposed in the brew chamber;
a vacuum source configured to communicate a negative pressure to the brew chamber;
a water delivery system configured to deliver both non-ambient strike water and ambient diluting water to the brew chamber; and
a processor for controlling the agitation paddle and the vacuum.

2. The beverage brewing system of claim 1, wherein the brew chamber is open to atmospheric pressure.

3. The beverage brewing system of claim 2, wherein the brew chamber includes a porous filter disposed between the agitation paddle and a brew chamber base.

4. The beverage brewing system of claim 3, wherein the brew chamber is mounted onto the base and the vacuum source communicates with the brewing chamber through the base.

5. The beverage brewing system of claim 1, wherein the brew chamber includes a cover that rotates from a closed position to hold the paddle in place and prevent splashing, and an open position to allow removal of the agitation paddle.

6. The beverage brewing system of claim 1, wherein a beverage is evacuated from the brew chamber using the vacuum source.

7. A cold brew beverage brewing apparatus, comprising:
a housing;
a brewing chamber;
a base supporting the brewing chamber;
an agitation system including a motor and paddle that rotates within the brewing chamber;
a vacuum pump in fluid connection with the base for causing a negative pressure condition in the brew chamber; and
a controller for controlling a brewing operation including initiating a wetting step, an agitation step, and a vacuum transfer step within the brew chamber.

8. The cold brew beverage brewing apparatus of claim 7, wherein the brew chamber is open to the atmosphere at some period during the brewing operation.

9. The cold brew beverage brewing apparatus of claim 7, wherein the brew chamber is clamped to a platform via a lever.

10. The cold brew beverage brewing apparatus of claim 7, wherein the controller controls a speed of the agitation paddle.

11. The cold brew beverage brewing apparatus of claim 10, wherein the agitation paddle is removable from the brewing apparatus.

12. A method for brewing coffee using a coffee brewing apparatus, the method comprising:
providing a brew chamber with coffee grounds;
introducing hot (strike) water to the grounds;
agitating a slurry of grounds and hot water using an agitation system;
introducing ambient water into the brewing chamber;
introducing a vacuum source into the brew chamber to accelerate the transfer of concentrated coffee extracts from the grounds; and
diluting a resulting concentrate with additional water after the vacuum transfer step.

13. The method for brewing coffee of claim 13, further comprising the coffee brewing apparatus accessing recipes from a remote location.

14. The method for brewing coffee of claim 12, wherein the vacuum source is located within the coffee brewing apparatus.

15. A beverage brewing system comprising:
a non-pressurized, removable brew chamber;
an agitation motor;
a removable agitation paddle rotated by the agitation motor and disposed in the brew chamber and magnetically coupled to a shaft of the agitation motor;
a vacuum source;
a beverage receptacle fluidly connected between the vacuum source and the brew chamber and configured to communicate a negative pressure from the vacuum source to the brew chamber;
a water delivery system configured to deliver both non-ambient strike water and ambient diluting water to the brew chamber; and
a processor for controlling the agitation paddle and the vacuum.
